(19) United States
(12) Patent Application Publication
(10) Pub. No.: US 2019/0314126 A1
(43) Pub. Date: Oct. 17, 2019

(54) FLOSSING TOOL

(71) Applicant: Sean O'Hara, Fort Montgomery, NY (US)

(72) Inventor: Sean O'Hara, Fort Montgomery, NY (US)

(21) Appl. No.: 15/952,899

(22) Filed: Apr. 13, 2018

(51) Int. Cl. A61C 15/04

(52) U.S. Cl. CPC A61C 15/046; A61C 15/041

(57) ABSTRACT

A flossing tool having a handle and a head. The head includes a first peg, a second peg, a third peg and a fourth peg. Each of the pegs include a channel circumferentially formed where the respective peg meets the head. A user attaches floss to the flossing tool by wrapping floss around the first peg then around the second peg then around the third peg and then around the fourth peg.

### BACKGROUND OF THE INVENTION

The present invention relates to a device to improve oral hygiene in humans and, more particularly, to an improved flossing tool.

The dental floss pick has existed in some form since the 1970's, with contemporaneous devices following the inadequate teaching of previous devices. U.S. Pat. No. 3,949,769, issued to Minka, uses dental floss imbedded in a handle, which wraps to a head and around two pegs. Minka uses a clamp to hold dental floss in place rather than channels. U.S. Pat. No. 4,657,033, issued to Dalton, wraps dental floss around two pegs and secures the floss immediately at the point of usage. U.S. Pat. No. 5,280,797, issued to Fry, secures dental floss on a handle between to pegs with a winding post. One positive teaching of Dalton and Fry is that they use aftermarket dental floss instead of the thin wire floss commonly found on dental picks today. Aftermarket floss is preferred to the wire floss shown in Minka because it provides a longer edge that is better equipped to remove debris from teeth.

These references all fall into the fallacy of supporting floss with two pegs. In practice, this is insufficient to hold the floss into place because vibration causes the floss to become unhinged.

As can be seen, there is a need for an improved dental floss tool that prevents floss from unhinging.

### SUMMARY OF THE INVENTION

In one aspect of the present invention, a flossing tool comprises: a handle; a head extending from the handle, the head comprising a front surface, a rear surface opposite the front surface and an edge; four pegs protruding from the front surface of the head, wherein each of the four pegs comprise a channel circumferentially formed where the respective peg meets with the head.

In another aspect of the present invention, a method of attaching floss to a flossing tool comprises the steps of: providing the flossing tool comprising: a handle; a head extending from the handle, the head comprising a front surface, a rear surface opposite the front surface and an edge; and four pegs protruding from the front surface of the head, wherein each of the four pegs comprise a channel circumferentially formed where the respective peg meets with the head; and wrapping a floss within the channels of each of the four pegs in a consecutive order.

These and other features, aspects and advantages of the present invention will become better understood with reference to the following drawings, description and claims.

### BRIEF DESCRIPTION OF THE DRAWINGS

FIG. 1 is a front view of an embodiment of the present invention;

FIG. 2 is a side view of an embodiment of the present invention;

FIG. 3 is a top view of an embodiment of the present invention;

FIG. 4 is a perspective view of an embodiment of the present invention;

FIG. 5 is a section detail view of an embodiment of the present invention;

FIG. 6 is a section detail view of an embodiment of the present invention;

FIG. 7 is a perspective view of an embodiment of the present invention in use; and

FIG. 8 is a perspective view of an embodiment of the present invention in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Embodiments of the present invention overcome many of the obstacles associated with the use of dental floss, and now will be described more fully hereinafter with reference to the accompanying drawings that show some, but not all embodiments of the claimed inventions. Indeed, the invention may be embodied in many different forms and should not be construed as limited to the embodiments set forth herein.

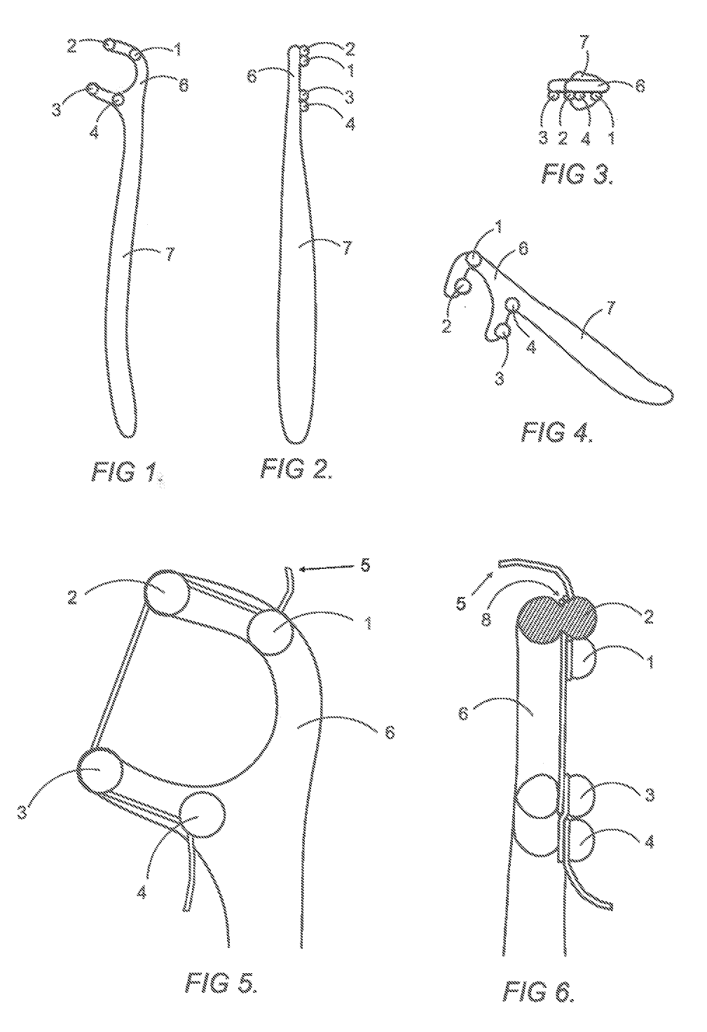

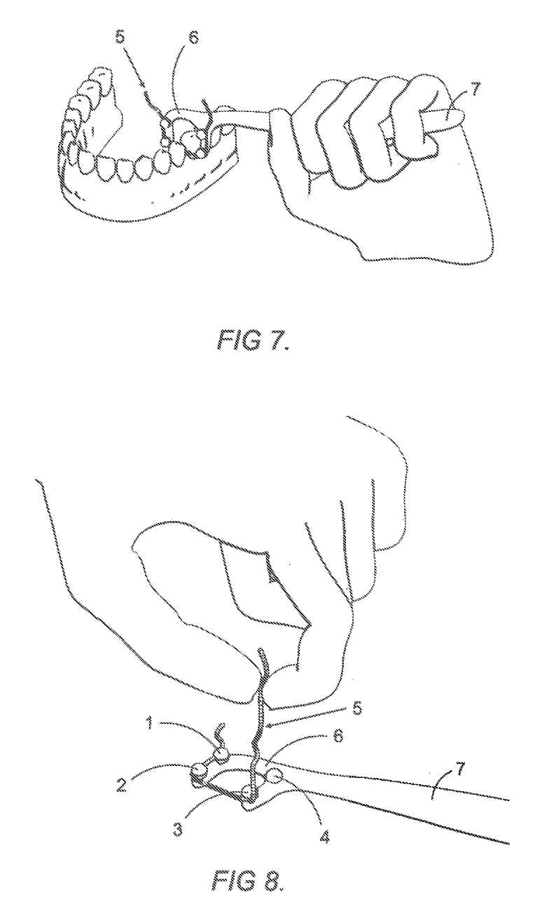

Referring to FIGS. 1 through 8, the improved flossing tool 10 includes a handle 7 and a head 6. The handle 7 may be a smooth handle about six to seven inches long. The handle 7 can be made of thermoplastic materials such as polyvinyl chloride (PVC). The head 6 extends from a top end of the handle 7. The head 6 includes a front surface, a rear surface opposite the front surface, and an edge. The head 6 can be a separate element connected to handle 7 or head 6 can be a molded part of handle 7. The handle 7 may also include a front surface contiguous with the front surface of the head 6, a rear surface contiguous with the rear surface of the head 6 and an edge contiguous with the edge of the head 6. To make the present invention, a thermoplastic may be heated and formed into a shape, then allowed to cool and harden.

In certain embodiments, four pegs may be affixed to the head 6: a first peg 1; a second peg 2; a third peg 3; and fourth peg 4. Each peg may be made of a thermoplastic material and cured in a single unit with the head 6 in the manner stated above. Each of the four pegs include a channel 8 circumferentially formed where the respective peg meets with the head 6. Each of the pegs may include a bulbous shape. For example, each of the pegs is an oblate spheroid protruding from a spheroid shape of the head 8 forming a channel 8 at the intersection of the oblate spheroid and the spheroid.

In certain embodiments, the head 6 forms a C-shape including a first arm, a second arm, and a base. The first arm and the second arm each include a proximal end and a distal end. The proximal ends are joined to the base. The distal ends are spaced apart. In such embodiments, the first peg 1 protrudes from the proximal end of the first arm, the second peg 2 protrudes from the distal end of the first arm, the third peg 3 protrudes from the distal end of the second arm and the fourth peg 4 protrudes from a proximal end of the second arm. The four pegs align to form a parallelogram, such as a rectangle or a square shape.

The improved flossing tool allows a user to wrap dental floss 5 around the first peg 1, the second peg 2, the third peg, 3 and the fourth peg 4 on the head 6 such that the floss 5 may be connected from first peg 1 then to second peg 2 then to third peg 3 and then to fourth peg 4. The floss 5 may be wrapped around each peg three times in a counter clock-wise direction and the floss 5 may be wrapped around each peg so that the floss 5 is in the channel 8 on each peg. The channel 8 on each peg cause the vibration in the floss 5 to be distributed on floss segments between the pegs, as a result the floss 5 stays in place. To remove the floss 5 from the flossing device 10, the user simply pulls up on the section of floss 5 hanging from fourth peg 4, which causes the floss 5 to unravel and expedites floss disposal. The floss 5 can be easily applied and removed from the present invention in a few seconds.

A method of using the present invention may include the following. A user winds the floss 5 around the pegs on the head 6 as noted above. The floss 5 can be pushed down and used to scoop debris from between teeth as aftermarket dental floss. Two alignments of the pegs can be used depending on user preference, FIG. 5 shows the pegs aligned such that the centers of the first peg 1, the second peg 2, the third peg 3 and the fourth peg 4 would make a rectangle. The Figures illustrate the pegs aligned such that the centers of the first peg 1, the second peg 2, the third peg 3 and the fourth peg 4 make a parallelogram disposed at approximately a 20 degree angle relative to the handle.

It should be understood, of course, that the foregoing relates to exemplary embodiments of the invention and that modifications may be made without departing from the spirit and scope of the invention as set forth in the following claims.

What is claimed is:

1. A flossing tool comprising:
a handle;
a head extending from the handle, the head comprising a front surface, a rear surface opposite the front surface and an edge;
four pegs protruding from the front surface of the head, wherein
each of the four pegs comprise a channel circumferentially formed where the respective peg meets with the head.

2. The flossing tool of claim 1, wherein the head forms a C-shape comprising a first arm, a second arm, and a base, wherein the first arm and the second arm each comprise a proximal end and a distal end, wherein the proximal ends are joined to the base.

3. The flowing tool of claim 2, wherein the four pegs comprise a first peg protruding from the proximal end of the first arm, a second peg protruding from the distal end of the first arm, a third peg protruding from the distal end of the second arm and a fourth peg protruding from a proximal end of the second arm.

4. The flossing tool of claim 1, wherein the four pegs align to form a parallelogram.

5. The flossing tool of claim 1, wherein the handle comprises a front surface contiguous with the front surface of the head, a rear surface contiguous with the rear surface of the head and an edge contiguous with the edge of the head.

6. The flossing tool of claim 1, wherein each of the four pegs comprise a bulbous shape.

7. The flossing of claim 6, wherein each of the four pegs is an oblate spheroid protruding from a spheroid shaped head such that the channel exists at an intersection of the oblate spheroid and the spheroid.

8. The flossing tool of claim 1, wherein the handle and the head are made of a thermoplastic.

9. A method of attaching floss to a flossing tool comprising the steps of:
providing the flossing tool comprising:
a handle;
a head extending from the handle, the head comprising a front surface, a rear surface opposite the front surface and an edge; and
four pegs protruding from the front surface of the head, wherein
each of the four pegs comprise a channel circumferentially formed where the respective peg meets with the head; and
wrapping a floss within the channels of each of the four pegs in a consecutive order.

10. The method of claim 9, wherein the floss is wrapped around each of the four pegs three times.
